(19) United States
(12) Patent Application Publication
(10) Pub. No.: US 2025/0103311 A1
(43) Pub. Date: Mar. 27, 2025

(54) SYSTEMS AND METHODS FOR DEPLOYING AN APPLICATION ON AN OPTIMAL CLOUD PLATFORM

(71) Applicant: Wells Fargo Bank, N.A., San Francisco, CA (US)

(72) Inventors: David Bendert, Charlotte, NC (US); Maximilian Fuchs, Charlotte, NC (US); Matthew Spain, Charlotte, NC (US)

(21) Appl. No.: 18/161,590

(22) Filed: Jan. 30, 2023

(51) Int. Cl. G06F 8/60; H04L 67/10

(52) U.S. Cl. CPC G06F 8/60; H04L 67/10

(57) ABSTRACT

Systems, apparatuses, methods, and computer program products are disclosed for optimizing cloud deployment of an application. An example method includes receiving, by communications hardware, a cloud deployment request and identifying, by an application analysis engine, a set of application configuration parameters for an application. The example method further includes selecting, by a cloud platform selection engine and based on the set of application configuration parameters for the application, an optimal cloud platform from a plurality of candidate cloud platforms and deploying, by a cloud deployment, the application on the optimal cloud platform.

### BACKGROUND

Migrating applications to new platforms is often necessary to reduce costs and simplify operations. However, the variable needs of applications and/or the offerings of current cloud platforms may present significant challenges to entities.

### BRIEF SUMMARY

In general, embodiments of the present invention provided herein provide a method to deploy an application on an optimal cloud platform.

As discussed above, determining which cloud platform to deploy an application to presents with significant organizational challenges to entities. In particular, each cloud platform has a set of cloud configuration parameters that describes the configuration, policies, rules, and/or settings that are associated with a particular cloud computing platform. For example, cloud configuration parameters may describe an associated cost policy, a set of acceptable application blueprints, cloud platform policy rules, and/or the like. One challenge that entities (e.g., an individual, an organization, or the like) are faced with when determining which cloud platform to deploy an application to, is whether the cloud platform offerings and the desired application requirements are compatible. However, assessing the compatibility between an application and different cloud platforms may be a burdensome manual task that requires evaluation by a skilled software engineer. Additionally, given the large number of available cloud platforms and applications of an entity, it may either not be feasible or may be time consuming and costly to manually evaluate the compatibility of each cloud application for a given application.

Furthermore, cloud configuration parameters of a cloud platform may be dynamic in nature such that they are subject to change. For example, a cloud platform may have various security incidents that happen in real-time or near real-time. As another example, a cloud platform may update it's associated costs and services. Therefore, entities may need to conduct assessments of each cloud platform prior to deployment of an application in order to accurately assess how well a given cloud platform suits the needs of the application as well as the needs of the entity. However, determining a set of cloud configuration of parameters for each cloud platform presents a significant challenge to entities. For example, entities may waste computational recourses by repeatedly searching for new sets of cloud configuration parameters for each cloud platform while there has been no update for the cloud configuration parameters for the cloud platforms. Without access to an efficient method for determining when to assess each cloud platforms configuration parameters, an entity may risk wasting computational recourses and/or remaining with their current cloud platform, which may not be the optimal cloud platform for an application.

Similarly to cloud platforms, applications may also be associated with a set of application configuration parameters. The application configuration parameters describe the configuration, policies, rules, and/or settings that are associated with a particular application. In particular, application configuration parameters may describe the various operating requirements for a particular application that must be met to run an application on a cloud platform. Application configuration parameters are dynamic and may also frequently change, making it difficult to accurately assess the compatibility between the application and a given cloud platform. For example, an entity may have an application containing person identifiable information that is deployed on a cloud platform that offers high security, but the cloud platform may have a high cost associated with running the application. The entity may later decide (e.g., through a new business strategy) to remove any sensitive information and prioritize the speed at which the application is run, which may change the cloud platform determined to be the optimal cloud platform.

In contrast to these conventional techniques for deploying an application on a cloud platform, example embodiments described herein optimize cloud deployment of an application to a selected optimal cloud platform. Example embodiments may collect and maintain cloud platform cloud configuration parameters for a variety of candidate cloud platform via various sources. Example embodiments may also collect and maintain application configuration parameters via various sources. The cloud configuration parameters and application configuration parameters may then be compared to one another to filter out any cloud platforms that are not configured to support, handle, or otherwise execute the application. As such, only cloud platforms determined to be capable of executing a given application may be selected for further processing, thus saving on associated processing costs. Furthermore, a cloud platform suitability scoring framework may employ one or more models (e.g., an extraction model, per-component category models, and a cloud platform suitability score determination machine learning model) to evaluate determine an overall cloud platform suitability score for each candidate cloud platform in order to determine and select an optimal cloud platform for the application. Additionally, the extraction model may determine application configuration parameter subsets, which categorize relevant application configuration parameters based on associated cloud platform suitability categories, such that only application configuration parameters which are relevant for the particular cloud platform suitability category are further processed and/or considered for a given associated cloud platform suitability category.

Example embodiments may also generate an impact report following a transition to an optimal cloud platform describing how the optimal cloud platform's cloud configuration parameters compliments the application configuration parameters of the application and may outline the various performance metrics of the application on the cloud platform and previously used cloud platforms to allow the user to easily visualize and evaluate the various cloud platforms. In some embodiments, recommendations for prospective applications may also be generated and optionally, included in the impact report. These recommendations may provide further insight on the performance of various cloud platforms for a variety of an entity's application, thereby allowing the entity to make informed decisions regarding the design and processing of their future applications.

Accordingly, the present disclosure sets forth systems, methods, and apparatuses that generate an overall score for each candidate cloud platform. There are many advantages of these to justify migrating an application to a new cloud platform. In addition, entities may use example embodiments herein to assess how a change in application configuration parameters and/or cloud configuration parameters may impact the optimal cloud platform to deploy an application. Further, entities may use example embodiments herein to passively and periodically search for an optimal cloud platform amidst changing application and cloud configuration parameters.

In one example embodiment, a method is provided for optimizing cloud deployment of an application. The method includes receiving, by a communications hardware, a cloud deployment request, wherein the cloud deployment request is associated with the application. The method further includes, identifying, by an application analysis engine, a set of application configuration parameters for the application. The method further includes, selecting by a cloud platform selection engine and based on the set of application configuration parameters for the application, an optimal cloud platform from a plurality of candidate cloud platforms. The method further includes, deploying, by a cloud deployment engine, the application on the optimal cloud platform.

In another example embodiment, an apparatus is provided for optimizing cloud deployment of an application. The apparatus includes communication hardware configured to receive a cloud deployment request, wherein the cloud deployment request is associated with the application. The apparatus further includes an application analysis engine configured to identify a set of application configuration parameters for the application. The apparatus further includes a cloud platform section engine configured to select an optimal cloud platform from a plurality of candidate cloud platforms based on the set of application configuration parameters for the application. The apparatus further includes a cloud deployment engine configured to deploy the application on the optimal cloud platform.

In another example embodiment, a computer program product is provided for optimizing cloud deployment of an application. The computer program product includes at least one non-transitory computer-readable storage medium storing software instructions that, when executed, cause an apparatus to receive a cloud deployment request, wherein the cloud deployment request is associated with the application. The at least one non-transitory computer-readable storage medium storing the software instructions that, when executed, further cause an apparatus to identify a set of application configuration parameters for the application and select based on the set of application parameters for the application, an optimal cloud platform from a plurality of candidate cloud platforms. The at least one non-transitory computer-readable storage medium storing the software instructions that, when executed, further cause an apparatus to deploy the application on the optimal cloud platform.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for optimizing cloud deployment of an application, in accordance with some example embodiments described herein.

FIG. 2 illustrates a schematic block diagram of example circuitry embodying a device that may perform various operations in accordance with some example embodiments described herein.

FIG. 3 illustrates a schematic block diagram of an example cloud platform suitability scoring framework, which may be used in accordance with some example embodiments described herein.

FIG. 4 illustrates an example flowchart for optimizing cloud deployment of an application, in accordance with some example embodiments described herein.

FIG. 5 illustrates an example flowchart for selecting an optimal cloud platform, in accordance with some example embodiments described herein.

FIG. 6 illustrates an example flowchart for determining an overall cloud platform suitability score, in accordance with some example embodiments described herein.

FIG. 7 illustrates an operational example of an impact report, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” is used herein to refer to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” is used to refer to any computing device capable of functioning as a server, such as a master exchange server, web server, mail server, document server, or any other type of server. A server may be a dedicated computing device or a server module (e.g., an application) hosted by a computing device that causes the computing device to operate as a server.

The word “example” is used to mean “serving as an example, instance, or illustration”. Any implementation described herein as “example” is not necessarily to be construed as preferred or advantageous over other implementations.

The term “storage devices” may refer to any electronic device capable of storing data. For example, a data storage repository or data warehouse are considered storage devices.

The terms “data”, may be used interchangeably to refer to data capable of being transmitted, received, and/or stored in accordance with embodiments of the present invention. Thus, use the term “data” should not be taken to limit the spirit or scope of embodiments of the present invention. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, remote servers, cloud-based servers (e.g., cloud utilities), relays, routers, network access points, base stations, hosts, and/or the like.

The term “cloud deployment request” refers to a data construct configured to describe a request for an optimal cloud platform to be determined for an associated application. The cloud deployment request may describe an application name, application identifier, application components, and/or the like such that the particular application is uniquely identifiable. In some embodiments, the cloud deployment request may describe an application package, which includes a plurality of individual applications and/or application components for which an optimal cloud platform is requested. The cloud deployment request may be received from one or more user devices and/or the system device in response to a manual user request or an automatic trigger event. An automatic trigger event may include a temporal trigger event, a circumstantial trigger event, and/or the like. A temporal trigger event may describe rules and/or configurations that require a cloud deployment request for an application to be generated within a particular time period or at a particular point in time. A circumstantial trigger event may describe rules and/or configurations that require that a cloud deployment request be generated in response to a set of conditions and/or criteria being met.

The term “application configuration parameters” refers to a data construct that describes the configuration, policies, rules, and/or settings that are associated with a particular application. In particular, application configuration parameters may describe the various operating requirements for a particular application that must be met to run an application on a cloud platform. For example, application configuration parameters may describe an application size, dependencies on other applications or software, runtime requirements, temporal requirements, and/or the like. In some embodiments, the application configuration parameters may further include historical data which describes information/data pertaining to historical executions of the application on various platforms. For example, the historical application data may describe an associated execution runtime, the particular cloud platform the application was deployed to, any alerts or warnings that occurred during the execution of the application, an associated cost, a start timestamp, an end timestamp, etc. for each previous deployment of the application.

The term “cloud configuration parameters” refers to a data construct that describes the configuration, policies, rules, and/or settings that are associated with a particular cloud computing platform. In particular, the cloud configuration parameters may describe the various operating rules for a particular cloud computing platform that must be met to run an application on the cloud platform. The cloud configuration parameters may be determined based at least in part on accessing a set of cloud platform specification data associated with the cloud platform, such as from a local repository or from a third-party (e.g., the cloud platform service itself). For example, cloud configuration parameters may describe an associated cost policy, a set of acceptable application blueprints, cloud platform policy rules, etc. In some embodiments, the cloud configuration parameters may further include historical performance data which describes information/data pertaining to historical executions of the application on various platforms. For example, the historical cloud data may describe security incident events, an associated runtime for each deployed application, an associated cost for each deployed application, an associated application deployment standby time, etc. In some embodiments, the cloud configuration parameters may be updated in an instance a cloud platform notification message is received. The cloud configuration notification message may describe one or more updates regarding the candidate cloud platform. As such, one or more cloud configuration parameters of the set of cloud configuration parameters for the cloud platform associated with the cloud platform notification message may be updated based on the one or more updates.

The term “cloud platform scoring framework” may describe a system architecture which may be used to process application and cloud configuration parameters to generate at least an overall score for each selected cloud platforms. The cloud platform scoring framework may include an extraction model, one or more per-component category models, and/or a cloud platform suitability determination machine learning model. In some embodiments, the cloud platform scoring framework may use the one or more included models to process the application configuration parameters and cloud configuration parameters, generate a plurality of per-category scores, and an overall cloud platform suitability score for each selected cloud platform.

The term “extraction model” may refer to a data construct that is configured to describe parameters, hyper-parameters, and/or stored operations of a machine learning model to process an input of application configuration parameters to generate one or more application configuration parameter subsets each associated with a particular cloud platform suitability category. The extraction model may provide each application configuration parameter subset to a per-component category model that is associated with the corresponding cloud platform suitability category. Alternatively, the extraction model may provide each application configuration parameter subset along with an indication of the particular cloud platform suitability category to a cloud platform suitability determination machine learning model. In some embodiments, the cloud platform suitability categories may include a security category, resiliency category, availability category, cost category, and/or the like. In some embodiments, the extraction model may be a trained classifier machine learning model and/or may use one or more natural language processing (NLP) techniques to process the application configuration parameters. In some embodiments, the application configuration parameter subsets may be formatted as a list, vector, array, and/or the like.

The term “per-component category model” may refer to a data construct that is configured to describe parameters, hyper-parameters, and/or stored operations of a model that is configured to process an application configuration parameter subset associated with a particular cloud platform suitability category and cloud configuration parameters for selected cloud platforms to generate a per-component category score for each candidate cloud platform. Each per-component category model may receive an indication of cloud configuration parameters for selected cloud platforms and an application configuration parameter subset from the extraction model. In some embodiments, each per-component category model may be a trained regression learning machine learning model configured to generate a per-component category score for each selected cloud platform. The per-component category score for a selected cloud platform may be indicative of how well the selected cloud platform may perform for a given cloud platform suitability category. The per-component category score may follow a fixed scale and a per-component category score value may be indicative of the ranking of a particular selected cloud platform with respect to the scale. As such, per-component category score across different selected cloud platforms may be directly compared. In some embodiments, the per-component category model may first generate a raw per-component category score which is then normalized based on the fixed scale and based on the cloud configuration parameters (e.g., the set of historical performance data for the selected cloud platform. The raw per-component category score may be normalized with respect to an accepted industry average. For example, a fixed scale may range between −1 and 1, where −1 indicates the worst possible per-component category score and 1 indicates the best per-component category score. A per-component category model may determine a raw per-component category score of 1 for selected cloud platform A but since cloud platform A has only one data point in the historical performance data, the per-component category score may be normalized to 0.5. The per-component category scores may be formatted as a multi-dimensional list, matrix, multi-dimensional array, and/or the like, where each position within the respective data structure is associated with a particular selected cloud platform.

The term “cloud platform suitability determination machine learning model” may refer to a data construct that is configured to describe parameters, hyper-parameters, and/or stored operations of a machine learning model that is configured to process one or more per-component category scores from each per-component model to generate an overall cloud platform suitability score. In some embodiments, the cloud platform suitability determination machine learning model is a trained regression machine learning model that is configured to process each per-component category score as received from each per component model to generate an overall cloud platform suitability score for each selected cloud platform. In some embodiments, the cloud platform suitability determination machine learning model may be trained using a training data set which includes previous per-component category scores and previous application configuration parameters. The cloud platform suitability determination machine learning model may be configured to generate the overall cloud platform suitability score for a respective cloud platform based on the one or more per-component category scores pertaining to the cloud platform. In some embodiments, each per-component category score may be weighted using a parameter obtained during cloud platform suitability determination machine learning model training. In some embodiments, the cloud platform suitability determination machine learning model may also receive user feedback indicative of a particular cloud platform suitability category to prioritize. As such, the cloud platform suitability determination machine learning model may adjust weights for the respective per-component category score accordingly. The overall cloud platform suitability scores may be formatted as a multi-dimensional list, matrix, multi-dimensional array, and/or the like, where each position within the respective data structure is associated with a particular selected cloud platform.

Alternatively, the cloud platform suitability determination machine learning model may be configured to process the one or more application configuration parameter subsets each associated with a particular cloud platform suitability category as received from the extraction model. The cloud platform suitability determination machine learning model may then directly determine the overall cloud platform suitability score for each selected cloud platform by processing the application configuration parameter subsets to generate the overall cloud platform suitability score.

### System Architecture

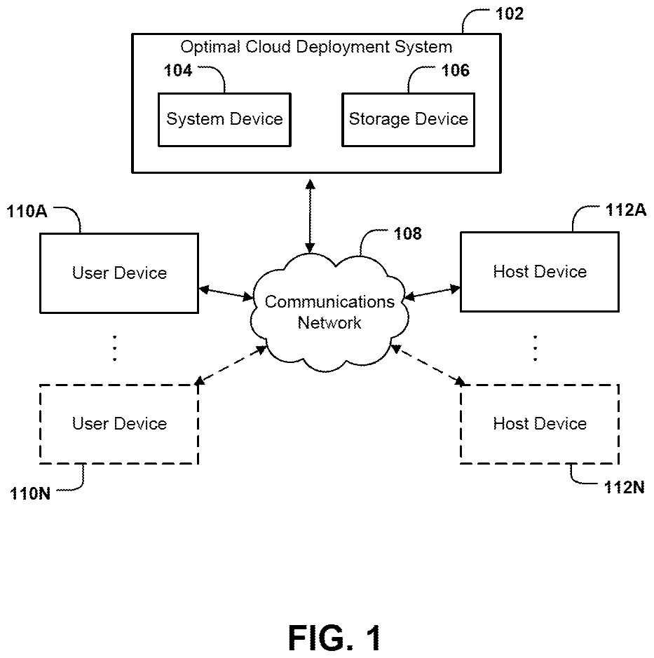

Example embodiments described herein may be implemented using any of a variety of computing devices or servers. To this end, FIG. 1 illustrates an example environment within which various embodiments may operate. As illustrated, an optimal cloud deployment system 102 may include a system device 104 in communication with a storage device 106. Although system device 104 and storage device 106 are described in singular form, some embodiments may utilize more than one system device 104 and/or more than one storage device 106. Additionally, some embodiments of the optimal cloud deployment system 102 may not require a storage device 106 at all. Whatever the implementation, the optimal cloud deployment system 102, and its constituent system device(s) 104 and/or storage device(s) 106 may receive and/or transmit information via communications network 108 (e.g., the Internet) with any number of other devices, such as one or more of user device 110A through user device 110N and/or host device 112A through host device 112N.

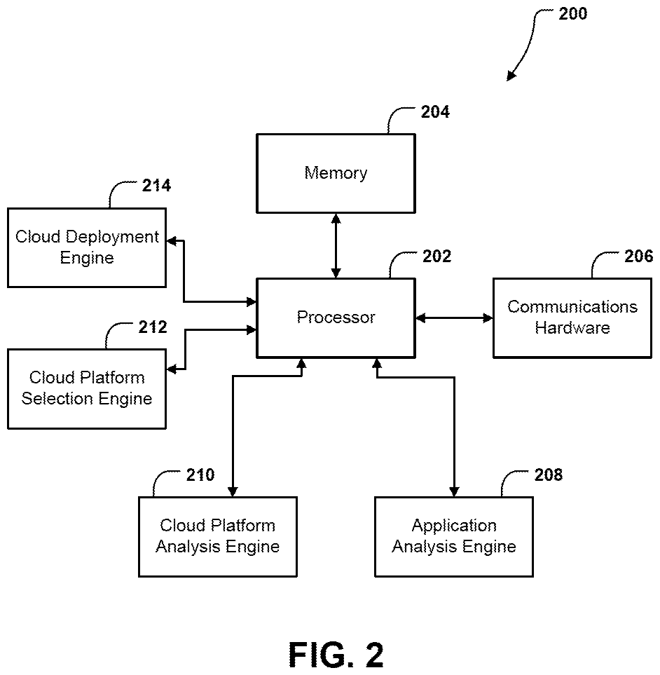

System device 104 may be implemented as one or more servers, which may or may not be physically proximate to other components of optimal cloud deployment system 102. Furthermore, some components of system device 104 may be physically proximate to the other components of optimal cloud deployment system 102 while other components are not. System device 104 may receive, process, generate, and transmit data, signals, and electronic information to facilitate the operations of the optimal cloud deployment system 102. Particular components of system device 104 are described in greater detail below with reference to apparatus 200 in connection with FIG. 2.

Storage device 106 may comprise a distinct component from system device 104, or may comprise an element of system device 104 (e.g., memory 204, as described below in connection with FIG. 2). Storage device 106 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Storage device 106 may host the software executed to operate the optimal cloud deployment system 102. Storage device 106 may store information relied upon during operation of the optimal cloud deployment system 102, such as various algorithms that may be used by the optimal cloud deployment system 102, data and documents to be analyzed using the optimal cloud deployment system 102, or the like. In addition, storage device 106 may store control signals, device characteristics, and access credentials enabling interaction between the optimal cloud deployment system 102 and one or more of the user devices 110A-110N or host devices 112A-112N.

The one or more user devices 110A-110N may be embodied by any user devices known in the art, such as desktop or laptop computers, tablet devices, smartphones, or the like. Similarly, the one or more host devices 112A-112N may be embodied by any host devices known in the art, such as desktop or laptop computers, virtual machines, or the like. The user devices 110A-110N and host devices 112A-112N need not themselves be an independent device, but may be a peripheral device communicatively coupled to other computing devices.

In some embodiments, one or more of host devices 112A-112N may serve as an infrastructure layer that is configured to provide one or more cloud computing platforms, which serve one or more applications. For example, a subset of host devices including 112A-112C are associated with a cloud platform X, a subset of host devices including 112D-112H are associated with a cloud platform Y, and a subset of host devices including 112J-112N are associated with a cloud platform Z. A cloud computing platform may be a private cloud accessible only to certain parties over a private internet, a public cloud accessible to any party over the public internet, or a hybrid cloud which has elements of both a public cloud and a private cloud.

Although FIG. 1 illustrates an environment and implementation in which the optimal cloud deployment system 102 interacts with one or more of user device 110A through user device 110N and/or host device 112A through host device 112N, in some embodiments users may directly interact with the optimal cloud deployment system 102 (e.g., via input/output circuitry of system device 104), in which case separate user devices 110A-110N may not be utilized. Whether by way of direct interaction or via separate user devices 110A-110N, a user may communicate with, operate, control, modify, or otherwise interact with the optimal cloud deployment system 102 to perform the various functions and achieve the various benefits described herein.

### Example Implementing Apparatuses

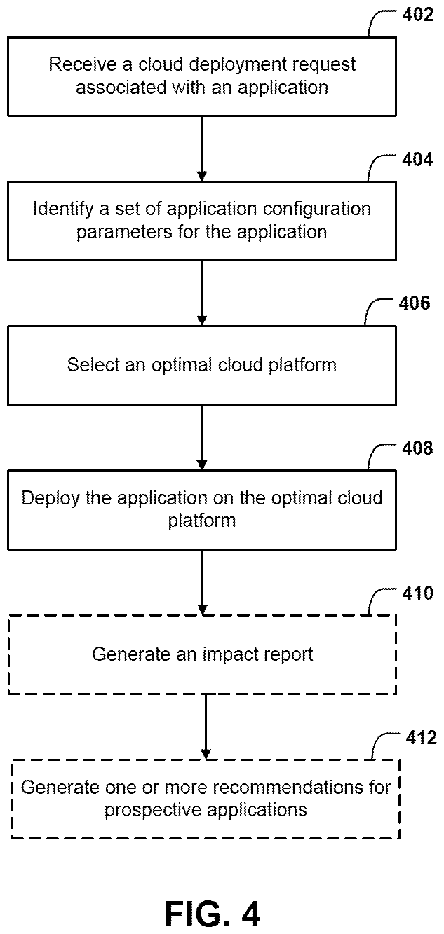

System device 104 of the optimal cloud deployment system 102 (described previously with reference to FIG. 1) may be embodied by one or more computing devices or servers, shown as apparatus 200 in FIG. 2. As illustrated in FIG. 2, the apparatus 200 may include processor 202, memory 204, communications hardware 206, application analysis engine 208, cloud platform analysis engine 210, cloud platform selection engine 212, and cloud deployment engine 214, each of which will be described in greater detail below. While the various components are only illustrated in FIG. 2 as being connected with processor 202, it will be understood that the apparatus 200 may further comprises a bus (not expressly shown in FIG. 2) for passing information amongst any combination of the various components of the apparatus 200. The apparatus 200 may be configured to execute various operations described above in connection with FIG. 1 and below in connection with FIGS. 4-6.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor (e.g., software instructions stored on a separate storage device 106, as illustrated in FIG. 1). In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises an application analysis engine 208, which may be configured to identify a set of application configuration parameters for a given application. In some embodiments, the application analysis engine may be configured to determine one or more additional applications that may be combined with a given application and append the one or more additional applications to a corresponding cloud deployment request. The application analysis engine 208 may utilize processor 202, memory 204, or any other hardware component included in the apparatus 200 to perform these operations, as described in connection with FIGS. 4-6 below. The application analysis engine 208 may further utilize communications hardware 206 to gather data from a variety of sources (e.g., user device 110A through user device 110N, host device 112A through host device 112N, or storage device 106, as shown in FIG. 1), and/or exchange data with a user, and in some embodiments may utilize processor 202 and/or memory 204 to perform any or more of the above operations.

In addition, the apparatus 200 further comprises a cloud platform analysis engine 210, which may be configured to select one or more cloud platforms for an application. The one or more cloud platforms may be selected from a plurality of candidate cloud platforms based on the set of application configuration parameters associated with the application and a set of cloud configuration parameters associated with a particular candidate cloud platform. In some embodiments, the cloud platform analysis engine 210 may also be configured to determine one or more cloud configuration parameters for a cloud platform based on a set of cloud platform specification data. In some embodiments, the cloud platform analysis engine 210 may also be configured to update one or more cloud configuration parameters of the set of cloud configuration parameters for the candidate cloud platform based on one or more updates regarding a cloud platform as described by a cloud platform notification message. The cloud platform analysis engine 210 may utilize processor 202, memory 204, or any other hardware component included in the apparatus 200 to perform these operations, as described in connection with FIGS. 4-6 below. The cloud platform analysis engine 210 may further utilize communications hardware 206 to gather data from a variety of sources (e.g., user device 110A through user device 110N, host device 112A through host device 112N, or storage device 106, as shown in FIG. 1), and/or exchange data with a user, and in some embodiments may utilize processor 202 and/or memory 204 to perform any or more of the above operations.

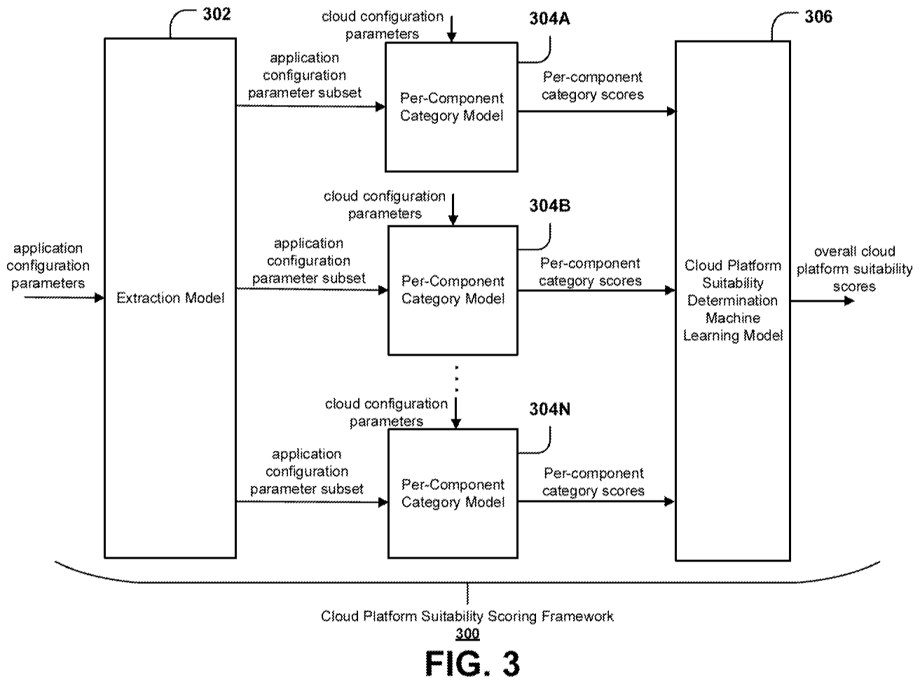

In addition, the apparatus 200 further comprises a cloud platform selection engine 212, which may be configured to select an optimal cloud platform from the one or more selected cloud platforms. In some embodiments, the cloud platform selection engine may be configured to select the optimal cloud platform based on the set of cloud configuration parameters associated with each candidate cloud platform and the set of application configuration parameters. In some embodiments, the cloud platform selection engine may be configured to determine an overall cloud platform suitability score for selected cloud platforms and/or one or more per-component category scores for the selected cloud platforms. In particular, the cloud platform selection engine 212 may leverage various models of the cloud platform suitability scoring framework 300 (e.g., extraction model 302, per-component category models 304A-304N, and/or cloud platform suitability determination machine learning model 306) to determine the optimal cloud platform. The cloud platform suitability scoring framework 300 is described in further detail below in connection with FIG. 3. The cloud platform selection engine 212 may utilize processor 202, memory 204, or any other hardware component included in the apparatus 200 to perform these operations, as described in connection with FIGS. 4-6 below. The cloud platform selection engine 212 may further utilize communications hardware 206 to gather data from a variety of sources (e.g., user device 110A through user device 110N, host device 112A through host device 112N, or storage device 106, as shown in FIG. 1), and/or exchange data with a user, and in some embodiments may utilize processor 202 and/or memory 204 to perform any or more of the above operations.

In addition, the apparatus 200 further comprises a cloud deployment engine 214, which may be configured to deploy an application on the optimal cloud platform. In some embodiments, the cloud deployment engine 214 may further be configured to determine whether an application is currently executing on a cloud platform that is not the optimal cloud platform and if so, determine a transition time point for the application. In some embodiments, the cloud deployment engine 214 may further be configured to generate an impact report. In some embodiments, the cloud deployment engine 214 may further be configured to generate one or more recommendations for prospective applications based on the impact report. The cloud deployment engine 214 may utilize processor 202, memory 204, or any other hardware component included in the apparatus 200 to perform these operations, as described in connection with FIGS. 4-6 below. The cloud deployment engine 214 may further utilize communications hardware 206 to gather data from a variety of sources (e.g., user device 110A through user device 110N, host device 112A through host device 112N, or storage device 106, as shown in FIG. 1), and/or exchange data with a user, and in some embodiments may utilize processor 202 and/or memory 204 to perform any or more of the above operations.

Although components 202-214 are described in part using functional language, it will be understood that the particular implementations necessarily include the use of particular hardware. It should also be understood that certain of these components 202-214 may include similar or common hardware. For example, the application analysis engine 208, cloud platform analysis engine 210, cloud platform selection engine 212, and cloud deployment engine 214 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry,” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the application analysis engine 208, cloud platform analysis engine 210, cloud platform selection engine 212, and cloud deployment engine 214 may leverage processor 202, memory 204, or communications hardware 206 as described above, it will be understood that any of these elements of apparatus 200 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or memory 204, or communications hardware 206 for enabling any functions not performed by special-purpose hardware elements. In all embodiments, however, it will be understood that the application analysis engine 208, cloud platform analysis engine 210, cloud platform selection engine 212, and cloud deployment engine 214 are implemented via particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. Thus, some or all of the functionality described herein may be provided by third party circuitry. For example, a given apparatus 200 may access one or more third party circuitries via any sort of networked connection that facilitates transmission of data and electronic information between the apparatus 200 and the third party circuitries. In turn, that apparatus 200 may be in remote communication with one or more of the other components describe above as comprising the apparatus 200.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of flowcharts.

### Example Operations

Turning now to FIGS. 4-6, example flowcharts are illustrated that contain example operations implemented by example embodiments described herein. The operations illustrated in FIGS. 4-6 may, for example, be performed by system device 104 of the optimal cloud deployment system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, application analysis engine 208, cloud platform analysis engine 210, cloud platform selection engine 212, cloud deployment engine 214 and/or any combination thereof. It will be understood that user interaction with the optimal cloud deployment system 102 may occur directly via communications hardware 206, or may instead be facilitated by a separate user device (e.g., user device 110A-110N), as shown in FIG. 1, and which may have similar or equivalent physical componentry facilitating such user interaction.

Turning first to FIG. 4, example operations are shown for optimizing cloud deployment of an application. As shown by operation 402, the apparatus 200 includes means, such as processor 202, memory 204, communications hardware 206, or the like, for receiving a cloud deployment request associated with an application. A cloud deployment request may describe a request for an optimal cloud platform to be determined for an associated application. In some embodiments, the cloud deployment request may describe an application name, application identifier, application components, and/or the like such that the particular application described by the cloud deployment request is uniquely identifiable.

In some embodiments, the cloud deployment request may describe an application package, which includes a plurality of individual applications and/or application components for which an optimal cloud platform is requested. The plurality of individual applications and/or application components may be packaged together because they have dependencies on each other, similar application components, or the like. For example, an entity may wish to deploy a first application and second application on an optimal cloud platform. A user device 110A-110N may transmit a cloud deployment request which describes an application package which includes the first application and the second application such that an optimal cloud platform may be determined for both applications. In some embodiments, the applications included in the application package may be treated separately (e.g., an optimized cloud platform is separately determined for each application), or the applications may be treated as bundled applications which are configured to be processed together.

In some embodiments, the cloud deployment request may further describe details pertaining to the request for an optimal cloud platform. For example, the cloud deployment request may describe a deployment request time indicative of a desired time for the application to be deployed to the optimal cloud platform. As another example, the cloud deployment request may describe one or more end users to whom at least a portion of, or the entirety of output resulting from deployment of the application to the optimal cloud platform may be transmitted to.

In some embodiments, the cloud deployment request may be received by the communications hardware 206. For example, the cloud deployment request may be transmitted to the apparatus 200 from a separate computing device (e.g., a user device 110A-110N, or the like) that is connected to the apparatus 200 via a network (e.g., communications network 108, FIG. 1), which may be in response to a manual request. In some embodiments, the cloud deployment request may be automatically generated and subsequently received from the apparatus 200, such as via processor 202, in response to an automatic trigger event.

In some embodiments, the cloud deployment request may be received in response to a manual user request or an automatic trigger event. As described above, a user may manually interact with a computing device, such as user device 110A via associated user interface(s), which in turn may cause the user device to generate the cloud deployment request based on received input from the user. For example, a user may interact with the user device 110A to indicate a desire to find an optimal cloud platform for application A for a deployment request time of “now” such that the user device 110A may generate the cloud deployment request describing a request for an optimal cloud platform to be determined for application A and for a deployment request time of “now” and provide the cloud deployment request to communications hardware 206.

Additionally or alternatively, detection of an automatic trigger event may cause the cloud deployment request to be generated by an external computing entity (e.g., user devices 110A-110N) or by apparatus 200, such as by processor 202. An automatic trigger event may include a temporal trigger event, a circumstantial trigger event, and/or the like. A temporal trigger event may describe rules and/or configurations that require a cloud deployment request for an application to be generated within a particular time period or at a particular point in time. For example, a computing entity (e.g., user devices 110A-110N or apparatus 200) may automatically generate a cloud deployment request in response to a temporal trigger event, where the temporal trigger event requires that a cloud deployment request be generated for application A every day at a certain time point (e.g., 9:00 am). As another example, the temporal trigger event may require the cloud deployment request to be generated at a particular time point which is determined based on the time point when the cloud deployment request for the application was previously generated and/or received (e.g., 24 hours after the previous cloud deployment request was generated and/or received). As yet another example, the temporal trigger event may require the cloud deployment request to be generated at least once within 48 hours from the time point when the cloud deployment request for the application was previously generated and/or received. In the instance no cloud deployment request is received within this time frame, trigger the generation of a cloud deployment request. A circumstantial trigger event may describe rules and/or configurations that require that a cloud deployment request be generated in response to a set of conditions and/or criteria being met. For example, a computing entity (e.g., user devices 110A-110N or apparatus 200) may automatically generate a cloud deployment request in response to a circumstantial trigger event, where the circumstantial trigger event requires that a cloud deployment request be generate for application A any time a cloud deployment request is generated and/or received for application B. As will be appreciated by one of skill in the art, an application may be associated with any number of automatic trigger events.

In some embodiments, if one or more cloud deployment requests are received for a particular application within a particular time frame (e.g., prior to a deployment request time), the most recent cloud deployment request may be selected and override previous cloud deployment requests. For example, if a previous cloud deployment request described a deployment request time of 10 am for application A and a more recently received cloud deployment request described a deployment request time of 9 am for application A, the more recent cloud deployment request may be selected such that the previous deployment request time of 10 am is updated to 9 am for application A.

As shown by operation 404, the apparatus 200 includes means, such as processor 202, memory 204, communications hardware 206, application analysis engine 208, or the like, for identifying a set of application configuration parameters for an application. In some embodiments, one or more application configuration parameters may be included in the cloud deployment request and identified based on the cloud deployment request. The cloud deployment request may be formatted or otherwise configured with particular application configuration parameter data fields and corresponding application configuration parameter data field values such that apparatus 200 (e.g., via application analysis engine 208) is configured to identify one or more application configuration parameters of the set of application configuration parameters based on the cloud deployment request. The application analysis engine 208 may use any suitable techniques to identify application configuration parameters included in the cloud deployment request, such as optical character recognition (OCR), natural language processing (NLP), searching algorithms, machine learning models and/or the like.

In some embodiments, the one or more application configuration parameters may be identified by accessing associated stored application configuration parameters from an associated repository. For example, the application analysis engine 208 may process the cloud deployment request and identify a described application identifier which uniquely identifies the application. The application analysis engine 208 may then perform one or more search queries on known repositories (e.g., storage device 106 or a remote database) using the application identifier to identify store application configuration data pertaining to the application. In some embodiments, the application configuration parameters may be stored in an application profile within a particular data repository (e.g., storage device 106 or a remote database) and may be accessed via a query with the corresponding application identifier. In some embodiments, in order to access the stored application configuration parameters, one or more credentials may be required. In some embodiments, the cloud deployment request may include one or more credentials such that the application analysis engine 208 may use the one or more credentials included in the cloud deployment request. Additionally or alternatively, in some embodiments, the application analysis engine 208 may be configured to generate and provide a request for one or more credentials to one or more computing entities, such as user devices 110A-110N. For example, a request for one or more credentials may be provided to the computing entity which provided the cloud computing request. The request for one or more credentials may be interactable such that an end user may input his/her credentials and application analysis engine 208 may receive a response which includes one or more input credentials, via communications hardware 206.

Application configuration parameters may describe a configuration, policies, rules, and/or settings that are associated with a particular application. Additionally, application configuration parameters may describe the various operating requirements for a particular application that must be met to run an application on a cloud platform. For example, application configuration parameters may describe an application size, dependencies on other applications or software, runtime requirements, temporal requirements, and/or the like. In some embodiments, the application parameters may be determined by processing an application using one or more associated application models. For example, an application model may be a software testing model configured to test an associated application under various application test scenarios. The performance of the application within the test scenarios may be used to determine runtime requirements, dependencies on other applications or software, and an application size. As another example, an application model may use OCR, natural language processing, machine learning models (e.g., long short-term memory (LSTM) models) and/or the like to identify text within the code of an application, such as code comments, which may indicate one or more application configuration parameters such as when the application should be run, dependencies on other applications or software, etc. In some embodiments, the one or more application models may process application metadata to determine one or more application configuration parameters. Once identified, application configuration parameters may be stored in a corresponding application profile. If no application profile is identified, an application profile may be generated for the application and an application identifier may be assigned to the application profile.

In some embodiments, the application configuration parameters may describe whether the application is associated with one or more special considerations categories. A special consideration category may be indicative of a sensitivity, vulnerability, susceptibility, or the like of the application to a particular condition. Special consideration categories may include but are not limited to a security consideration category, a resiliency consideration category, a availability consideration category, a cost consideration category, and/or the like. For example, if the application includes, references, or otherwise uses personal identifiable information (PII) data, the application may be associated, either manually or by application analysis engine 208 (e.g., via one or more application models), with a security consideration category indicating that security is of heightened importance when deploying the particular application.

In some embodiments, the application configuration parameters may include historical data which describes information/data pertaining to historical executions of the application on various platforms. The historical application data may describe an associated execution runtime, the particular cloud platform the application was deployed to, alerts or warnings that occurred during the execution of the application, an associated cost, a start timestamp, an end timestamp, etc. for each previous deployment of the application. In some embodiments, once an application is deployed to a cloud platform and the application is executed, the cloud platform may provide application feedback data to the apparatus 200, which may serve as historical application data. Alternatively, the communications hardware 206 may retrieve or request historical data from a host device 112A-112N which are associated with the cloud platform. The historical application data may be stored in the associated application profile.

As shown by operation 406, the apparatus 200 includes means, such as processor 202, memory 204, communications hardware 206, cloud platform selection engine 212, or the like, for selecting an optimal cloud platform. An optimal cloud platform for an application may be selected based on the set of application configuration parameters for the application. Furthermore, in some embodiments, the optimal cloud platform may be selected based on a set of cloud configuration parameters associated with each candidate cloud platform. The optimal cloud platform may describe the cloud platform that currently best and most appropriately suits the needs of the application and the entity associated with the cloud deployment request. The optimal cloud platform needs to be capable of successfully executing the application, as well as meeting the requirements as described by the cloud deployment request and furthermore, considering the needs of the entity associated with the cloud deployment request.

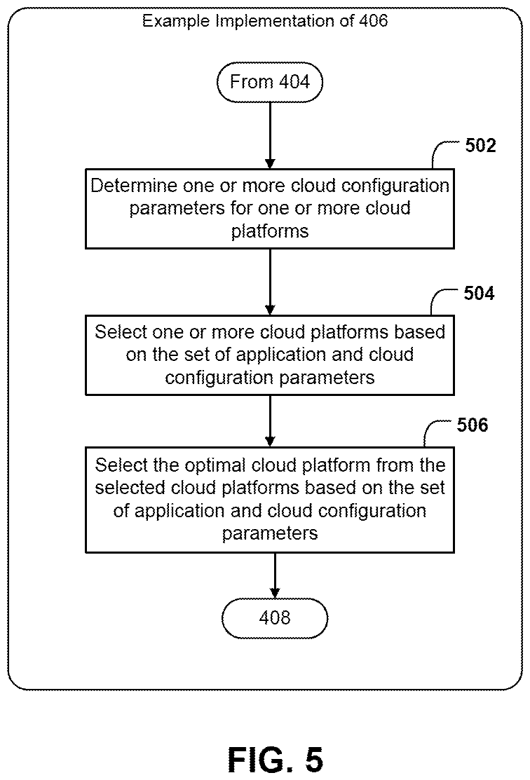

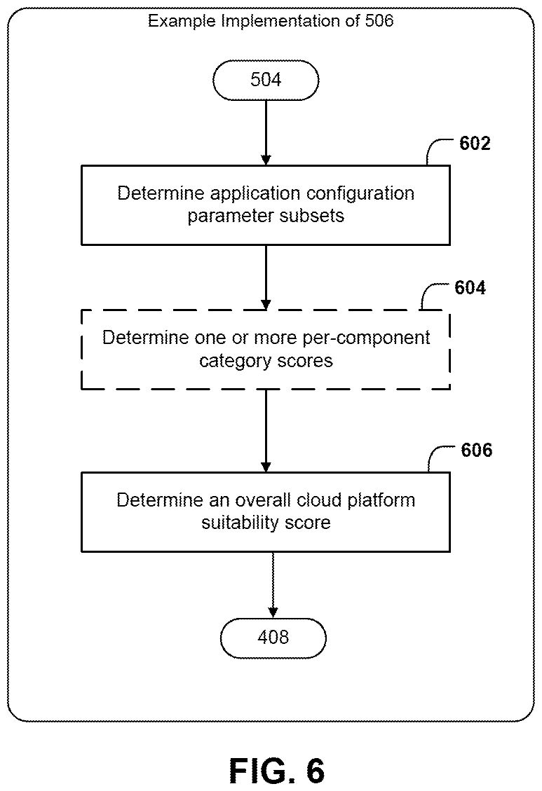

As a simplified example of selecting an optimal cloud platform, consider that candidate cloud deployment platforms X, Y, and Z may each be candidate cloud deployment platforms for an application A. Each of candidate cloud deployment platforms X, Y, and Z may be capable of executing application A and the cloud deployment request may describe application A be executed every 24 hours at 9 am. The runtime for application A may also be 12 hours, as described by the associated application configuration parameters. Candidate cloud platforms X and Y may historically have bandwidth to execute applications during the requested deployment time, but candidate cloud platform Z may historically be busy with other application executions such that the execution of application A may be delayed. Additionally, candidate cloud platform X may offer a flat fee of $500 per day, regardless of the number of hours an application is executed for whereas candidate cloud platform Y offers an hourly rate of $50. Although each of candidate cloud platforms X, Y, and Z are capable of executing application A, the only candidate cloud platforms X and Y are capable of meeting the availability requirements and candidate cloud platform X offers a more cost-effective option for the particular entity. Further details regarding how an optimal cloud platform is selected are further discussed in FIGS. 5-6.

In some embodiments, operation 406 may be performed in accordance with the operations described in FIG. 5. Turning to FIG. 5, detailed operations are shown for selecting an optimal cloud platform.

As shown by operation 502, the apparatus 200 includes means, such as processor 202, memory 204, communications hardware 206, cloud platform analysis engine 210, or the like, for determining one or more cloud configuration parameters for a plurality of candidate cloud platforms. Cloud configuration parameters may describe the configuration, policies, rules, and/or settings that are associated with a particular cloud computing platform. In particular, the cloud configuration parameters may describe the various operating rules for a particular cloud platform that must be met to run an application on the cloud platform. For example, a particular cloud platform may describe the default settings for an application to run on the particular cloud platform. In some embodiments, the cloud configuration parameters may be stored in a cloud platform profile within a particular data repository (e.g., storage device 106 or a remote database) and may be accessed via a query using a corresponding cloud platform identifier. Each cloud platform identifier may correspond to a particular candidate cloud platform and uniquely identify the associated cloud platform profile of the candidate cloud platform.

In some embodiments, the cloud configuration parameters may be determined based at least in part on accessing a set of cloud platform specification data associated with the cloud platform. The communications hardware 206 may access the cloud platform specification data associated with a cloud platform from a local repository or from a third-party (e.g., the cloud platform service itself) via a network (e.g., communications network 108, FIG. 1). A cloud platform analysis model may use OCR, natural language processing, machine learning models (e.g., LSTM models) and/or the like to process text from third-parties to identify one or more cloud configuration parameters. For example, the cloud platform analysis model may use a web crawler to collect, gather, or otherwise aggregate information pertaining to a particular candidate cloud platform, such as text describing operating rules for the candidate cloud platform. The text may be identified using any suitable technique (e.g., OCR) and once identified, subsequently processed using any suitable technique (e.g., an LSTM model) to generate one or more cloud configuration parameters for the candidate cloud platform. For example, the cloud platform analysis engine 210 may use a web crawler to capture text describing a price or offering of executing an application on the website of a cloud platform provider and process the text to identify the cost associated with deploying an application on the cloud platform.

Additionally, in some embodiments, the cloud configuration parameters may further include historical performance data which describes information/data pertaining to historical executions of the application on various platforms. For example, the historical cloud data may describe security incident events, an associated runtime for each deployed application, an associated cost for each deployed application, an associated application deployment standby time, etc. In some embodiments, once an application is deployed to a cloud platform and the application is executed, the cloud platform may provide application feedback data to the apparatus 200, which may serve as historical application data. Alternatively, the communications hardware 206 may retrieve or request historical data from a host device 112A-112N associated with the cloud platform. The historical application data may be stored in the associated application profile.

In some embodiments, the cloud configuration parameters may be updated and/or generated in an instance the communications hardware 206 receives a cloud platform notification message from a host device 112A, which is associated with a particular cloud platform. The cloud configuration notification message may describe one or more updates regarding the candidate cloud platform. As such, one or more cloud configuration parameters of the set of cloud configuration parameters for the cloud platform associated with the cloud platform notification message may be updated and/or one or more cloud configuration may be generated by the cloud platform analysis engine 210 based on the one or more updates. For example, a cloud platform may transmit a cloud platform notification message via a network (communications network 108, FIG. 1) describing a change in the price offered by the cloud platform. The cloud platform analysis engine may update the cloud configuration parameters for the cloud platform to reflect the changes detailed in the message. As another example, a cloud platform may transmit a cloud platform notification message via a network (communications network 108, FIG. 1) describing a security incident, such as a server breach. The cloud platform analysis engine may generate a cloud configuration parameter which describes the security incident as detailed by the cloud platform notification message.

As shown by operation 504, the apparatus 200 includes means, such as processor 202, memory 204, communications hardware 206, cloud platform analysis engine 210, or the like, for selecting one or more cloud platforms based on the set of application and cloud configuration parameters. In some embodiments, the cloud platform analysis engine 210 may determine the compatibility of an application and a candidate cloud platform based on the application configuration parameters and cloud configuration parameters. In particular, the candidate cloud platform must be capable of handling and executing the application in order to be selected. Otherwise, even if this candidate cloud platform is otherwise determined to be an optimal cloud platform based on other criteria, as will be described in greater detail in FIG. 6, the cloud platform will not be capable of executing the application. As such, by selecting one or more cloud platforms from the plurality of candidate cloud platforms prior to further evaluation of the candidate cloud platform, this provides a method of filtration that removes any cloud platform that is incapable of executing the application described by the cloud deployment request, thus saving on computational resources and time by only processing select cloud platform applications determined to be capable of executing the application.

The cloud platform analysis engine 210 may retrieve the application configuration parameters and cloud configuration parameters from storage device 106, memory 204, or the like. Further, the cloud platform analysis engine 210 may utilize a comparative model, which may use any suitable analysis techniques (e.g., filtering, decision tree analytics, etc.) to determine if the application would be compatible with the cloud platform. For example, each application configuration parameter which specifies a requirement (e.g., a runtime requirement) must be satisfied by the cloud configuration parameters. The cloud platform analysis engine 210 may then output a determination as to whether a candidate cloud platform is either compatible or not compatible. If the candidate cloud platform is determined to be not compatible with the application, the candidate cloud platform will not be selected for further processing. Conversely, if the candidate cloud platform is determined to be compatible with the application, the candidate cloud platform may be selected and undergo further analysis and processing described in further detail in accordance with the operations of FIG. 6.

As shown by operation 506, the apparatus 200 includes means, such as processor 202, memory 204, communications hardware 206, cloud platform selection engine 212, or the like, for determining the optimal cloud platform from the selected cloud platforms based on the set of application and cloud configuration parameters. As described above, an optimal cloud platform for an application may be selected based on the set of application configuration parameters for the application and a set of cloud configuration parameters associated with the selected cloud platform. The optimal cloud platform may describe the cloud platform that currently best and most appropriately suits the needs of the application and the entity associated with the cloud deployment request.

In some embodiments, operations 506 may be performed in accordance with the operations described in FIG. 6. Turning to FIG. 6, example operations are shown for determining overall cloud platform suitability scores.

As shown by operation 602, the apparatus 200 includes means, such as processor 202, memory 204, communications hardware 206, cloud platform selection engine 212, or the like, for determining application configuration parameter subsets for the application. The cloud platform selection engine 212 may utilize extraction model 302 of the cloud platform suitability scoring framework 300 to determine the application configuration parameter subsets. In some embodiments, the application configuration parameter subsets may be a portion of the application configuration parameters. Each application configuration parameter subset may correspond to a particular cloud platform suitability category. In some embodiments, the cloud platform suitability categories may include a security category, resiliency category, availability category, cost category, and/or the like.

In some embodiments, application configuration parameters for an application may be used in multiple application configuration parameter subsets. For example, an application configuration parameter describing an associated execution runtime may be included in an application configuration parameter subset associated with a cost cloud platform suitability category and availability cloud platform suitability category. As another example, an application configuration parameter describing an associated cost may be included only in a cost cloud platform suitability category.

In some embodiments, the extraction model 302 of FIG. 3 may be used to determine one or more application configuration subsets for the application, each associated with a particular cloud platform suitability category. In some embodiments, the extraction model 302 may provide each application configuration parameter subset to a per-component category model 304A-304N that is associated with the corresponding cloud platform suitability category. Alternatively, the extraction model may provide each application configuration parameter subset along with an indication of the particular cloud platform suitability category to a cloud platform suitability determination machine learning model. In some embodiments, the extraction model may be a trained classifier machine learning model and/or may use one or more NLP techniques to process the application configuration parameters. In some embodiments, the application configuration parameter subsets may be formatted as a list, vector, array, and/or the like.

Optionally, as shown by operation 604, the apparatus 200 includes means, such as processor 202, memory 204, communications hardware 206, cloud platform selection engine 212, or the like, for determining one or more per-component category scores. In some embodiments, the cloud platform selection engine 212 may utilize the one or more per-component category models 304A-304N of the cloud platform suitability scoring framework 300 to determine the one or more per-component category scores as shown in FIG. 3. Each per-component category model 304A-304N may be trained for a particular cloud platform suitability category. For example, per-component category model 304A may be trained for and associated with a security cloud platform suitability category, per-component category model 304B may be trained for and associated with a resiliency cloud platform suitability category, per-component category model 304C may be trained for and associated with an availability cloud platform suitability category, and per-component category model 304N may be trained for and associated with a cost cloud platform suitability category.

Each per-component category model 304A-304N may receive the set of cloud configuration parameters for the one or more selected cloud platforms (e.g., as selected in operation 504 of FIG. 5) and an application configuration parameter subset associated with a corresponding cloud platform suitability category from the extraction model. In some embodiments, each per-component category model may be a trained regression learning machine learning model configured to generate a per-component category score for each of the one or more selected cloud platform. By way of continuing example, per-component category model 304A may receive the application configuration parameter subset associated with the security cloud platform suitability category, per-component category model 304B may receive the application configuration parameter subset associated with the resiliency cloud platform suitability category, per-component category model 304C may receive the application configuration parameter subset associated with the availability cloud platform suitability category, and per-component category model 304N may receive the application configuration parameter subset associated with the cost cloud platform suitability category. Then, per-component category model 304A may be configured to generate a per-component category score associated with the security cloud platform suitability category for each selected cloud platform, per-component category model 304B may be configured to generate a per-component category score associated with the resiliency cloud platform suitability category for each selected cloud platform, per-component category model 304C may be configured to generate a per-component category score associated with availability cloud platform suitability category for each selected cloud platform, and per-component category model 304N may be configured to generate a per-component category score for each associated with the cost cloud platform suitability category for each selected cloud platform.

The per-component category score for a selected cloud platform may be indicative of how well the selected cloud platform may perform for the associated cloud platform suitability category. The per-component category score may follow a fixed scale and a per-component category score value may be indicative of the ranking of a particular selected cloud platform with respect to the scale. As such, per-component category score across different selected cloud platforms may be directly compared.

In some embodiments, the per-component category model may first generate a raw per-component category score which is then normalized based on the fixed scale and based on the cloud configuration parameters (e.g., the set of historical performance data for the selected cloud platform). The raw per-component category score may be normalized with respect to an accepted industry average. For example, a fixed scale may range between −1 and 1, where −1 indicates the worst per-component category score and 1 indicates the best per-component category score. A per-component category model may determine a raw per-component category score of 1 for selected cloud platform A but since cloud platform A has only one data point in the historical performance data, the per-component category score may be normalized to 0.5. The per-component category scores may be formatted as a multi-dimensional list, matrix, multi-dimensional array, and/or the like, where each position within the respective data structure is associated with a particular selected cloud platform.

As shown by operation 606, the apparatus 200 includes means, such as processor 202, memory 204, communications hardware 206, cloud platform selection engine 212, or the like, for determining an overall cloud platform suitability score. In some embodiments, the cloud platform selection engine 212 may utilize the cloud platform suitability determination machine learning model 306 of the cloud platform suitability scoring framework 300 as shown in FIG. 3 to determine the overall cloud platform suitability scores. In some embodiments, the cloud platform suitability determination machine learning model 306 is a trained regression machine learning model that is configured to process each per-component category score as received from each per component model to generate an overall cloud platform suitability score for each selected cloud platform. In some embodiments, the cloud platform suitability determination machine learning model 306 may be trained using a training data set which includes previous per-component category scores and previous application configuration parameters.

The cloud platform suitability determination machine learning model 306 may be configured to generate the overall cloud platform suitability score for a respective cloud platform for each of the selected cloud platforms based on the one or more per-component category scores pertaining to the cloud platform. In some embodiments, each per-component category score may be weighted according to a parameter weight obtained during cloud platform suitability determination machine learning model training. In some embodiments, the cloud platform suitability determination machine learning model may also receive user feedback indicative of a particular cloud platform suitability category to prioritize. For example, an entity may communicate with the apparatus 200 via a network (e.g., communications network 108, FIG. 1) through a user device 110A to request an adjustment of the weights for the per-component category scores. As such, the cloud platform suitability determination machine learning model 306 may adjust weights for the respective per-component category score accordingly.

Additionally or alternatively, if the application is associated one or more application configuration parameters which indicate that the application is associated with one or more special considerations categories, the cloud platform suitability determination machine learning model may be configured to receive an indication of the one or more special considerations categories. The cloud platform suitability determination machine learning model may then adjust the weights for the per-component category scores based on the one or more one or more special considerations categories. For example, if an application configuration parameter describes that the application is associated with a security consideration category, the cloud platform suitability determination machine learning model 306 may weight the respective per-component category score corresponding to the security cloud platform suitability category. The overall cloud platform suitability scores may be formatted as a multi-dimensional list, matrix, multi-dimensional array, and/or the like, where each position within the respective data structure is associated with a particular selected cloud platform.

Alternatively, in some embodiments, the cloud platform suitability determination machine learning model may be configured to process the one or more application configuration parameter subsets each associated with a particular cloud platform suitability category as received from the extraction model without the need for intermediate processing by the one or more per-component category models 304A-304N. The cloud platform suitability determination machine learning model may then directly determine the overall cloud platform suitability score for each selected cloud platform by processing the application configuration parameter subsets to generate the overall cloud platform suitability score.

Returning to FIG. 5, as shown by operation 506 the apparatus 200 includes means, such as processor 202, memory 204, communications hardware 206, cloud platform selection engine 212, or the like, for selecting the optimal cloud platform based on the set of application and cloud configuration parameters. In some embodiments, the cloud platform selection engine 212 may receive the overall cloud platform suitability scores from the cloud platform suitability scoring framework 300. The overall cloud platform suitability scores may be ranked, for example from the most optimal cloud platform being the highest score to the least optimal cloud platform being the lowest score, to determine the optimal cloud platform for an application. Thus, the cloud platform selection engine 212 may select the cloud platform associated with best overall cloud platform suitability score as the optimal cloud platform.

Returning to FIG. 4, as shown by operation 408 the apparatus 200 includes means, such as processor 202, memory 204, communications hardware 206, cloud deployment engine 214, or the like, for deploying the application on the optimal cloud platform. In some embodiments, in response to the determination of an optimal cloud platform for the application, the cloud deployment engine 214 deploy the application on the optimal cloud platform. In some embodiments, the communications hardware 206 may transmit an application deployment request via a network (communications network 108, FIG. 1) to a host device 112A-112N which is associated with the optimal cloud platform. The application deployment request may describe all necessary data required for the optimal cloud platform to execute the application. For example, the application deployment request may include a reference to the application remotely stored within the optimal cloud platform environment if the application has previously been migrated to the particular cloud platform and may additionally include any additional data documents that may be required for execution of the application (e.g., spreadsheets, documents, or other data that may be processed by the application). As another example, the application deployment request may include the components of the application for the optimal cloud platform to use to execute the application, which may be useful in instances where the optimal cloud platform has not previously been used to execute the application. In some embodiments, the optimal cloud platform may create an instance of the application within the cloud storage such that in the future, the cloud platform may simply access the instance of the application for future application deployment requests, thus conserving computational bandwidth and resources associated with providing the entirety of the application components. In some embodiments, the application deployment request may include updated cloud components such that the optimal cloud platform may update a stored application data instance. As such, the cloud platform may be configured with the most current version of the application but without the computational burden of transmitting or providing the entirety of the application components to the cloud platform via the application deployment message.

In some embodiments, the application deployment request may be generated based on the cloud deployment request, as received in operation 402. For example, the application deployment request may indicate the deployment request time indicative of a desired time for the application to be deployed to the optimal cloud platform such that the optimal cloud platform may queue the application for execution at the requested time. Alternatively, the cloud deployment engine may generate and store the application deployment request until the deployment request time. As another example, the application deployment request may describe the one or more end users to whom at least a portion of, or the entirety of output resulting from deployment of the application to the optimal cloud platform may be transmitted to, as described by the cloud deployment request.

In some embodiments, before deploying the application on the optimal cloud platform, the cloud deployment engine 214 may determine whether the application is currently executing on a cloud platform. If the application is determined to have already been deployed on a particular cloud platform and the results from the application deployment have not yet been received, the cloud deployment engine 214 may determine the application is currently executing. Additionally or alternatively, the communications hardware 206 may communicate with host device 112A-112N associated with a cloud platform determined to be executing the application to determine the status of the application. In some embodiments, if the application is not currently running, the cloud deployment engine 214 may initiate a deployment of the application on the determined optimal cloud platform. In some other embodiments, if the application is running on the current cloud platform, which is not the optimal cloud platform, the cloud deployment engine 214 may determine a transition time point for the application. The transition time point may define a set of conditions (e.g., a duration of time to wait before deploying the application, or the like) that must be met for deploying the application on the optimal cloud platform.

As shown by operation 410 the apparatus 200 includes means, such as processor 202, memory 204, communications hardware 206, cloud deployment engine 214, or the like, for generating an impact report. In some embodiments, the apparatus 200 may display the impact report to the user via communications hardware 206, or the report may be transmitted via communications network 108 to one of the user devices 110A-110N. The cloud deployment engine 214 may generate the impact report according to a formatted output, for example as a webpage comprising visual representations of the per-component category scores and may make visual comparisons between the pervious cloud platform and the optimal cloud platform. The impact report may be customized to suit a particular style desired by a user. For example, a first entity may wish to view a report describing the differences between the previous cloud platform and the optimal cloud platform, while a second entity may wish to view a report describing the new cloud platform.

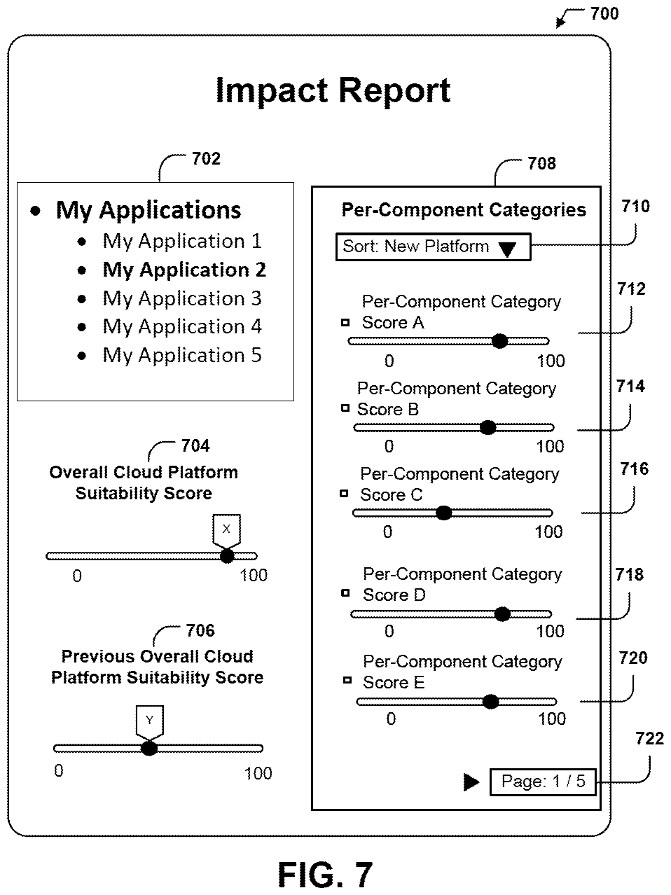

Turning to FIG. 7, an operation example of an example user interface 700 is shown for presenting the impact report to a user. The example user interface includes a list of applications 702, a graphical representation of the overall cloud platform suitability score 704, a graphical representation of the previous overall cloud platform suitability score, and the per-component categories 708.

The list of applications 702 may group impact reports in a directory (e.g., a folder), as shown in the example diagram as “My Applications”. The directories in the list of applications 702 may be selectable to expand or collapse the impact reports, and the individual impact reports may be selected to display the relevant impact report in the example user interface 700.

The overall cloud platform suitability score 704 and previous overall cloud platform suitability score 706 may give a summary numerical value to the overall suitability score for the new optimal cloud platform and the previous cloud platform. The user interface element may include a graphical reference that shows the overall cloud platform suitability score to a scale, for example a numerical scale from 0 to 100, or the like. The graphical reference may allow a user to better gauge the improvement of the optimal cloud platform compared to the previous cloud platform.

The detailed information about per-component categories 708 may include information about the various per-component categories of the cloud platform. The depicted list of per-component categories shows one possible example for a cloud platform with per-component categories A through E. Other example embodiments or impact reports of other optimal cloud platforms may list different per-component categories depending on the application configuration parameters and the cloud configuration parameters. The sorting method selector 710 may allow sorting of the per-component category scores. The sorting method selector 710 may sort the per-component category scores to display the per-component category scores of the new cloud platform, the old cloud platform, the difference in category scores between the new cloud platform and the old cloud platform, or the like. Per-component category scores 712 through 720 may be displayed with a numerical value of the respective per-component category score, and a user interface element may further give a graphical representation of the contribution feature value relative to some scale, for example a minimum of 0 and maximum of 100. Finally, a page selector 722 may be included to allow the user to view additional per-component category scores, recommendations (described below in relation to operation 412), or the like by advancing to the next page and/pr selecting a page from a listing of pages.

As shown by operation 412 the apparatus 200 includes means, such as processor 202, memory 204, communications hardware 206, cloud deployment engine 214, or the like, for generating one or more recommendations for prospective applications. In some embodiments, the recommendations for prospective applications may be appended to the impact report prior to the impact reports transmission to user devices 110A-110N. Alternatively, the recommendations for prospective applications may utilize cloud deployment engine 214 to produce another formatted output, for example as a webpage comprising visual representations of overall cloud platform suitability scores for other prospective applications the entity may wish to deploy on determined optimal cloud platforms.

In some embodiments, the cloud deployment engine 214 may use a recommendation model to generate one or more recommendations for an entity associated with the cloud deployment request. The recommendation model may be a machine learning model (e.g., a neural network) or deep learning model, which may be configured to process the one or more per-component category scores and/or overall cloud platform suitability scores for each selected cloud platform for a plurality of applications associated with the entity to generate one or more recommendations for the entity. In some embodiments, the recommendation model may be configured to generate synthetic per-component category scores and/or synthetic overall cloud platform suitability scores for each cloud platform that was not selected for an application for the plurality of application and include the generated synthetic per-component category scores and/or synthetic overall cloud platform suitability scores when determining the one or more recommendations. As such, the recommendation model may be configured to evaluate an overall inferred benefit or potential benefit (e.g., in the case of the cloud platforms not selected for further processing) to determine whether the entity should institute one or more changes in the associated policy.

For example, if a cloud platform N, which was not selected during the selection process as described in operation 504 of FIG. 5 due to incompatibilities between the application configuration parameter and cloud configuration parameters, but the synthetic generated data for the cloud platform N indicated the overall cloud platform suitability score for one or more applications would actually be significantly higher (e.g., above a threshold amount) than the other cloud platforms, the recommendation model may generate a recommendation to restructure the application to be compatible with the cloud platform N as well as an indication of the operational requirements of cloud platform N. The recommendation model may also recommend that future applications be configured to be compatible with cloud platform N. As such, the recommendation model may provide users with an indication of how to efficiently improve their applications for cloud deployment.

As described above, example embodiments provide methods and apparatuses that enable an improved ability for deploying an application on an optimal cloud platform. Example embodiments thus provide tools that overcome the problems faced by manually selecting a cloud platform for an application. By avoiding the need to manually search for an optimal cloud platform for an application, example embodiments thus save time as well as manual and computational resources. Finally, by automating the searching and selecting of an optimal cloud platform for an application, the increased efficiency of the optimal cloud platform selection process performed by example embodiments unlocks many potential new functions that have historically not been available, such as the ability to automatically search a plurality of candidate cloud platforms for an optimal cloud platform to account for the dynamic nature of cloud and application configuration parameters.

FIGS. 4, 5, and 6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be embodied by software instructions. In this regard, the software instructions which embody the procedures described above may be stored by a memory of an apparatus employing an embodiment of the present invention and executed by a processor of that apparatus. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a computer-readable memory that may direct a computing device or other programmable apparatus to function in a particular manner, such that the software instructions stored in the computer-readable memory produce an article of manufacture, the execution of which implements the functions specified in the flowchart blocks. The software instructions may also be loaded onto a computing device or other programmable apparatus to cause a series of operations to be performed on the computing device or other programmable apparatus to produce a computer-implemented process such that the software instructions executed on the computing device or other programmable apparatus provide operations for implementing the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for optimizing cloud deployment of an application, the method comprising:
receiving, by communications hardware, a cloud deployment request, wherein the cloud deployment request is associated with the application;
identifying, by an application analysis engine, a set of application configuration parameters for the application;
selecting, by a cloud platform selection engine and based on the set of application configuration parameters for the application, an optimal cloud platform from a plurality of candidate cloud platforms; and
deploying, by a cloud deployment engine, the application on the optimal cloud platform.

2. The method of claim 1, wherein selecting the optimal cloud platform includes:
selecting, by a cloud platform analysis engine, one or more cloud platforms from the plurality of candidate cloud platforms based on the set of application configuration parameters for the application and a set of cloud configuration parameters associated with each candidate cloud platform; and
selecting, by the cloud platform selection engine, the optimal cloud platform from the one or more selected cloud platforms based on the set of cloud configuration parameters associated with each candidate cloud platform and the set of application configuration parameters.

3. The method of claim 2, wherein selecting the optimal cloud platform further comprises:
determining, by the cloud platform selection engine and using a cloud platform scoring framework, an overall cloud platform suitability score for each of the one or more selected cloud platforms based on one or more cloud configuration parameters of the set of cloud configuration parameters and the set of application configuration parameters,
wherein the cloud platform selection engine selects the optimal cloud platform based on each overall cloud platform suitability score associated with each of the one or more selected cloud platforms.

4. The method of claim 3, wherein determining the overall cloud platform suitability score for each of the one or more selected cloud platforms further comprises:
determining, by the cloud platform selection engine and using the cloud platform scoring framework, one or more per-component category scores for each of the one or more selected cloud platforms, wherein (i) each per-component category score is associated with a cloud platform suitability category of one or more cloud platform suitability categories, (ii) each cloud platform suitability category is associated with the one or more cloud configuration parameters of the set of cloud configuration parameters, and (iii) each per-component category score is based on a the one or more cloud configuration parameters for a selected cloud platform corresponding to the cloud platform suitability category; and
determining, by the cloud platform selection engine, the overall cloud platform suitability score based on each of the one or more per-component category scores.

5. The method of claim 1, further comprising:
for a candidate cloud platform of the plurality of candidate cloud platforms:
accessing, by the communications hardware, a set of cloud platform specification data associated with the candidate cloud platform; and
determining, by a cloud platform analysis engine, one or more cloud configuration parameters of the set of cloud configuration parameters for the candidate cloud platform based on the set of cloud platform specification data.

6. The method of claim 5, further comprising:
accessing, by the communications hardware, a set of historical performance data associated with the candidate cloud platform,
wherein determining the one or more cloud configuration parameters for the candidate cloud platform is further based on the associated set of historical performance data.

7. The method of claim 5, further comprising:
receiving, by the communications hardware, a cloud platform notification message, wherein the cloud platform notification message is associated with the candidate cloud platform and describes one or more updates regarding the candidate cloud platform; and
updating, by the cloud platform analysis engine, the one or more cloud configuration parameters of the set of cloud configuration parameters for the candidate cloud platform associated with the cloud platform notification message based on the one or more updates.

8. The method of claim 1, wherein deploying the application on the optimal cloud platform includes:
determining, by the cloud deployment engine, whether the application is currently executing on a cloud platform that is not the optimal cloud platform; and
in an instance in which the application is currently executing on a cloud platform that is not the optimal cloud platform, determining, by the cloud deployment engine, a transition time point for the application, wherein the transition time point defines a set of conditions for deploying the application on the optimal cloud platform.

9. The method of claim 1, further comprising:
generating, by the cloud deployment engine, an impact report based on deployment of the application on the optimal cloud platform.

10. The method of claim 9, further comprising:
generating, by the cloud deployment engine, one or more recommendations for prospective applications based on the impact report.

11. The method of claim 1, further comprising:
determining, by the application analysis engine, one or more additional applications that can be combined with the application; and
appending, by the application analysis engine, the one or more additional applications to the cloud deployment request.

12. An apparatus for optimizing cloud deployment of an application, the apparatus comprising:
communications hardware configured to receive a cloud deployment request, wherein the cloud deployment request is associated with the application;
application analysis engine configured to identify, a set of application configuration parameters for the application;
cloud platform selection engine configured to select, based on the set of application configuration parameters for the application, an optimal cloud platform from a plurality of candidate cloud platforms; and
cloud deployment engine configured to deploy the application on the optimal cloud platform.

13. The apparatus of claim 12, further comprising:
a cloud platform analysis engine configured to select one or more cloud platforms from the plurality of candidate cloud platforms based on the set of application configuration parameters for the application and a set of cloud configuration parameters associated with each candidate cloud platform; and
wherein the cloud platform selection engine is further configured to select the optimal cloud platform from the one or more selected cloud platforms based on the set of cloud configuration parameters associated with each candidate cloud platform and the set of application configuration parameters.

14. The apparatus of claim 13, wherein the cloud platform selection engine is further configured to:
determine using a cloud platform scoring framework, an overall cloud platform suitability score for each of the one or more selected cloud platforms based on one or more cloud configuration parameters of the set of cloud configuration parameters and the set of application configuration parameters; and
select the optimal cloud platform based on each overall cloud platform suitability score associated with each of the one or more selected cloud platforms.

15. The apparatus of claim 14, wherein the cloud platform selection engine is further configured to:
determine using the cloud platform scoring framework, one or more per-component category scores for each of the one or more selected cloud platforms, wherein (i) each per-component category score is associated with a cloud platform suitability category of one or more cloud platform suitability categories, (ii) each cloud platform suitability category is associated with the one or more cloud configuration parameters of the set of cloud configuration parameters, and (iii) each per-component category score is based on a the one or more cloud configuration parameters for a selected cloud platform corresponding to the cloud platform suitability category; and
determine the overall cloud platform suitability score based on each of the one or more per-component category scores.

16. The apparatus of claim 12, wherein the communications hardware is further configured to access a set of cloud platform specification data associated with a candidate cloud platform of the plurality of candidate cloud platforms, and
wherein the apparatus further comprises a cloud platform analysis engine configured to determine one or more cloud configuration parameters of the set of cloud configuration parameters for the candidate cloud platform based on the set of cloud platform specification data.

17. A computer program product for optimizing cloud deployment of an application, the computer program product comprising at least one non-transitory computer-readable storage medium storing computer-executable instructions that, when executed, cause an apparatus to:
receive a cloud deployment request, wherein the cloud deployment request is associated with the application;
identify a set of application configuration parameters for the application;
select based on the set of application configuration parameters for the application, an optimal cloud platform from a plurality of candidate cloud platforms; and
deploy the application on the optimal cloud platform.

18. The computer program product according to claim 17, wherein the computer-executable instructions, when executed, further cause the apparatus to:
select one or more cloud platforms from the plurality of candidate cloud platforms based on the set of application configuration parameters for the application and a set of cloud configuration parameters associated with each candidate cloud platform; and
select the optimal cloud platform from the one or more selected cloud platforms based on the set of cloud configuration parameters associated with each candidate cloud platform and the set of application configuration parameters.

19. The computer program product according to claim 18, wherein the computer-executable instructions, when executed, further cause the apparatus to:
determine using a cloud platform scoring framework, an overall cloud platform suitability score for each of the one or more selected cloud platforms based on one or more cloud configuration parameters of the set of cloud configuration parameters and the set of application configuration parameters; and
select the optimal cloud platform based on each overall cloud platform suitability score associated with each of the one or more selected cloud platforms.

20. The computer program product according to claim 19, wherein the computer-executable instructions, when executed, further cause the apparatus to:
determine using the cloud platform scoring framework, one or more per-component category scores for each of the one or more selected cloud platforms, wherein (i) each per-component category score is associated with a cloud platform suitability category of one or more cloud platform suitability categories, (ii) each cloud platform suitability category is associated with the one or more cloud configuration parameters of the set of cloud configuration parameters, and (iii) each per-component category score is based on a the one or more cloud configuration parameters for a selected cloud platform corresponding to the cloud platform suitability category; and
determining the overall cloud platform suitability score based on each of the one or more per-component category scores.
